(19) United States
(12) Patent Application Publication
(10) Pub. No.: US 2011/0261016 A1
(43) Pub. Date: Oct. 27, 2011

(54) Optical touch screen system and method for recognizing a relative distance of objects

(75) Inventor: Chun-Wei Huang, Hsinchu City (TW)

(73) Assignee: Sunplus Innovation Technology Inc., Hsinchu City (TW)

(21) Appl. No.: 12/926,202

(22) Filed: Nov. 2, 2010

(30) Foreign Application Priority Data
Apr. 23, 2010 (TW) 099112910

(51) Int. Cl. G06F 3/042

(52) U.S. Cl. 345/175; 345/82

(57) ABSTRACT

An optical touch screen system for recognizing a relative distance of an object based on optical sensors includes a display screen to display visual prompts to solicit actions from a user; first and second lighting and sensing modules mounted on two adjacent corners of the display screen for forming first and second visual fields above the display screen respectively, wherein the first and the second visual fields intersect to form a touch area on the display screen, and the first and the second lighting and sensing modules detect an object entering the touch area and generate a first electrical position signal and a second electrical position signal respectively; and a processor for calculating a position of the object based on the first electrical position signal and the second electrical position signal.

### BACKGROUND OF THE INVENTION

1. Field of the Invention

The present invention relates to the technical field of image processing and, more particularly, to an optical touch screen system and method for recognizing relative distance of objects.

2. Description of Related Art

Currently, touch screens (i.e., touch panels) are in widespread use for being directly touched by an object or a finger to perform an operation instead of a mechanical button operation. When a user touches a picture on a screen, a sensing feedback system implemented on the screen can drive the connectors based on the pre-programmed codes, and the screen can present colorful audiovisual effects to completely control a human-machine interface.

There are several types of touch screens available in the market, which are resistive touch screen, capacitive touch screen, acoustic touch screen, and optical touch screen. The optical touch screen uses an optical sensor to receive a reflective light to thereby determine a position of an object entering a touch area. FIGS. 1 and 2 are schematic views of a typical optical touch screen. As shown in FIGS. 1 and 2, the optical touch screen 100 has a lighting device 110, a mask 120, an optical sensor 130 and a lens 140 implemented on a liquid crystal display (LCD). The lighting device 110 and the optical sensor 130 are implemented on the glass plate of the LCD at the right upper corner. The lighting device 110 illuminates, and the mask 120 filters out a part of light to thereby generate a parallel light source. When a finger or object enters into a touch space and generates a reflective light, the optical sensor 130 can collect the reflective light due to the finger or object locating in the touch space 160. FIG. 3 shows an image sensed by the optical sensor 130. The sensed image is processed by a processor (not shown) to calculate a position of the finger or object in the touch space 160. However, the sensed image generated by the finger or object are the same at points A and B because the use of one lighting device 110 and one optical sensor 130, as shown in FIG. 1, can determine 1D position only. Accordingly, the touch position obtained by such method is not accurate.

To overcome this, a method is proposed to use two lighting devices 110 and two optical sensors 130 in two pairs. FIG. 4 is a schematic view of another typical optical touch screen 400. The touch screen 400 uses two pairs of lighting devices 110 and optical sensors 130, one of which implemented on the glass plate of the LCD 150 at the right upper corner, and the other implemented on the glass plate of the LCD 150 at the left upper corner. Each of the two lighting devices 110 generates a light. The optical sensors 130 obtain images through the reflective light reflected by the touching object and calculate the respective angles of the touching object to thereby use a trigonometric function to find a coordinate of the touching object.

FIG. 5(A) is an image sensed by the optical sensor 130 of FIG. 4 at the right upper corner, and FIG. 5(B) is an image sensed by the optical sensor 130 of FIG. 4 at the left upper corner. FIG. 6 is a schematic view of a coordinate of a touching object calculated by a trigonometric function. The sensed images of FIGS. 5(A) and 5(B) are used to calculate the included angles α and β formed by intersecting the upper side of the LCD 150 and the reflective lights respectively, and the included angles α, β, and the lengths d, w of the sides of the LCD 150 are used to calculate the coordinate (X, Y) of the touching object.

When the touching object is a single object, it requires at least two optical sensors 130 for an accurate positioning, and when the touching object contains two objects, it requires three optical sensors 130 for an accurate positioning. Similarly, when the touching object contains three objects, it requires four optical sensors 130, and so on. Namely, the number of reference points increases as the number of objects increases, so the number of optical sensors 130 required also increases.

However, for saving the cost, the typical optical touch input device mostly includes two optical sensors 130, and in this case the accuracy of recognizing two or more objects is relatively reduced.

As the touching object contains two objects, an optical touch input device with two optical sensors 130 can obtain two reflected images at each optical sensor 130, as shown in FIGS. 7(A) and 7(B). FIG. 7(A) shows an image sensed by an optical sensor 130 at the right upper corner, and FIG. 7(B) shows an image sensed by an optical sensor 130 at the left upper corner. Four touching objects are obtained by combining the reflected images sensed by each optical sensor 130. FIG. 8 is a schematic view of images sensed by an optical touch input device with two optical sensors 130. As shown in FIG. 8, there are only two real objects A, B, and the other two objects C, D are referred to as ghost points. When the ghost points cannot be canceled, it makes an error in recognition. For example, a left rotation of gesture may be erroneously determined as a right rotation to thereby negatively affect the optical touching accuracy.

The optical touch input device with two optical sensors 130 can obtain the accuracy of 100% for a single touching object, of 50% for two touching objects, of 33.3% for three touching objects, of 25% for four touching objects, and so on. Namely, the accuracy decreases as the number of touching objects increases.

In order to avoid the mistake caused by the ghost points, the conventional technique requires some subsequent processes after the images are obtained. In the subsequent processes, the ghost point recognition method includes: (1) determining a width by using a sensed image to decide the width of light beam generated by a reflective light and using the width ratio to decide the distance of a touching object, which has a disadvantage of easily making a wrong decision when the touching object has a uniform width or an overlarge width error at different angles, for example, the wrong decision occurs when the width error of a finger at different angles is over 20%; (2) brightness level distribution and statistics, i.e., the distance of the object is determined by analyzing the ratio of grey scale to the maximum brightness since the grey scale effect is generated as the touching object reflects a light, wherein the error increases as the object's surface radian increases; and (3) adjusting the optical sensor into an inclined top visual direction such that its image presents a solid effect to thereby decide the distance of the object, but due to the inclination, an interference may be caused by a reflective light source when the light is reflected onto the surface.

Therefore, it is desirable to provide an improved optical touch screen system and method for recognizing relative distance of objects, so as to mitigate and/or obviate the aforementioned problems.

### SUMMARY OF THE INVENTION

The object of the present invention is to provide an optical touch screen system, which can accurately filter out ghost points and effectively increase the accuracy of multi-point touching.

According to a feature of the invention, an optical touch screen system is provided, which includes a display screen, a first lighting and sensing module, a second lighting and sensing module, and a processor. The display screen displays visual prompts to solicit actions from a user. The first and the second lighting and sensing modules are mounted at two adjacent corners of the display screen for forming a first and a second visual fields above the display screen, respectively, so as to form a touch area on the display screen, wherein the first and the second lighting and sensing modules detect an object entering the touch area and generate a first electrical position signal and a second electrical position signal, respectively. The processor is connected to the first and the second lighting and sensing modules for recognizing a position of the object based on the first electrical position signal and the second electrical position signal to thereby achieve a human-machine control. The first lighting and sensing module has a first lighting device mounted on a first mount location from the display screen to illuminate on a surface of the display screen at an auxiliary angle of a first mount angle. The second lighting and sensing module has a second lighting device mounted on a second mount height from the display screen to illuminate on the surface of the display screen at an auxiliary angle of a second mount angle.

According to another feature of the invention, a method for recognizing a relative distance of an object in an optical touch screen system is provided, which is used in a display screen to recognize a position where a user touches the display screen, wherein the first lighting and sensing module and the second lighting and sensing module are mounted on two adjacent corners of the display screen. The first lighting and sensing module has a first lighting device and a first sensing device. The second lighting and sensing module has a second lighting device and a second sensing device. The first lighting device is mounted at a first mount location from the display screen. The first lighting device has an axis of a lighting plane to form a first mount angle θ₁ with respect to the display screen. The second lighting device is mounted at a second mount height from the display screen. The second lighting device has an axis of a lighting plane to form a second mount angle θ₂ with respect to the display screen. The method includes the steps of: (A) using the first and the second lighting devices to form a first and a second visual fields above a display screen respectively so as to form a touch area on the display screen by intersecting the first visual field with the second visual field; (B) using the first and the second sensing devices to generate a first and a second electrical position signals for an object entering the touch area; and (C) using a processor to calculate a position of the object based on the first and the second electrical position signals.

According to a further feature of the invention, an optical touch screen system is provided, which includes a display screen, a first lighting and sensing module, a second lighting and sensing module, and a processor. The display screen displays visual prompts to solicit actions from a user. The first and the second lighting and sensing modules are mounted at two adjacent corners of the display screen for forming a first and a second visual fields above the display screen, respectively, so as to form a touch area on the display screen. A first electrical position signal and a second electrical position signal are generated when the first lighting and sensing module detects a first object entering the touch area, and a third electrical position signal and a fourth electrical position signal are generated when the second lighting and sensing module detects a second object entering the touch area. The processor is connected to the first and the second lighting and sensing modules for recognizing positions of the first and the second objects based on the first, the second, the third, and the fourth electrical position signals, so as to achieve a human-machine control. The first lighting and sensing module has a first lighting device mounted at a first mount location from the display screen to illuminate on a surface of the display screen at an auxiliary angle of a first mount angle. The second lighting and sensing module has a second lighting device mounted at a second mount height from the display screen to illuminate on the surface of the display screen at an auxiliary angle of a second mount angle.

Other objects, advantages, and novel features of the invention will become more apparent from the following detailed description when taken in conjunction with the accompanying drawings.

### BRIEF DESCRIPTION OF THE DRAWINGS

FIGS. 1 and 2 are schematic views of a typical optical touch screen;

FIG. 3 is a schematic view of an image sensed by a typical optical sensor;

FIG. 4 is a schematic view of another typical optical touch screen;

FIG. 5(A) is an image sensed by the optical sensor of FIG. 4 at the right upper corner;

FIG. 5(B) is an image sensed by the optical sensor of FIG. 4 at the left upper corner;

FIG. 6 is a schematic view of a coordinate of a touching object calculated by a triangle function;

FIG. 7(A) is an image sensed by the optical sensor of FIG. 4 at the right upper corner for two objects;

FIG. 7(B) shows an image sensed by the optical sensor of FIG. 4 at the left upper corner for two objects;

FIG. 8 is a schematic view of images sensed by an optical touch input device with two optical sensors;

FIG. 9 is a schematic view of an optical touch screen system according to an embodiment of the invention;

FIG. 10 is a side view of an optical touch screen system according to an embodiment of the invention;

FIG. 11 is a schematic view of calculating a first mount angle according to an embodiment of the invention;

FIG. 12 is a schematic view of calculating a distance from a touching object to a first lighting and sensing module according to an embodiment of the invention; and

FIG. 13 a flowchart of an optical touch screen method according to an embodiment of the invention.

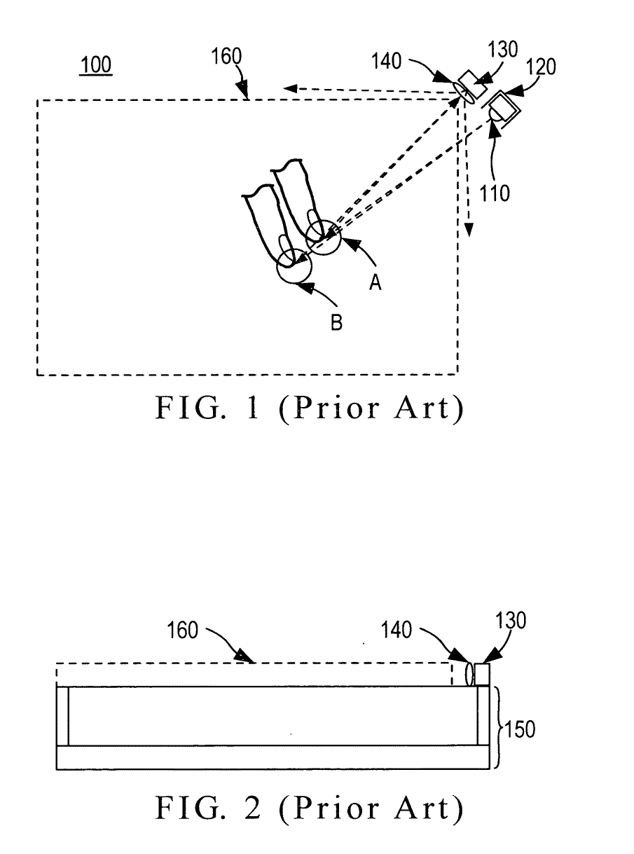

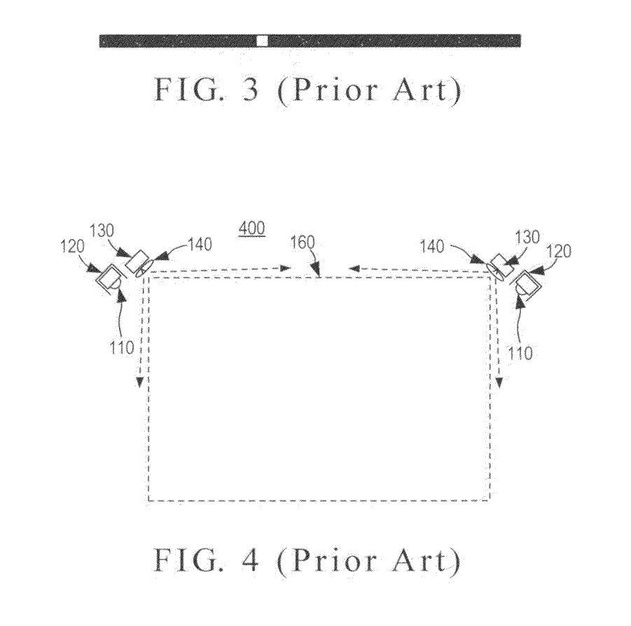

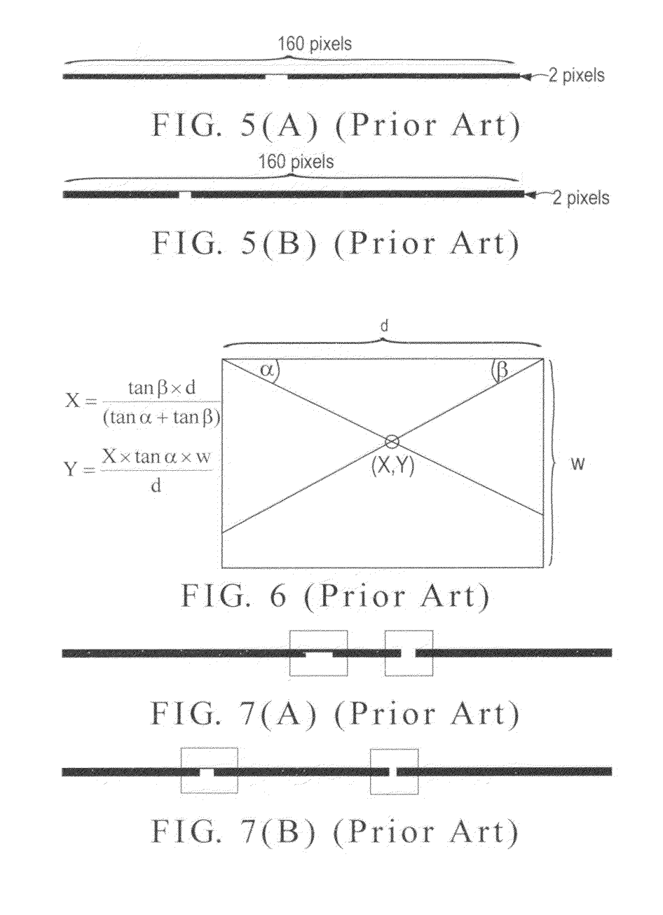

### DETAILED DESCRIPTION OF THE PREFERRED EMBODIMENT

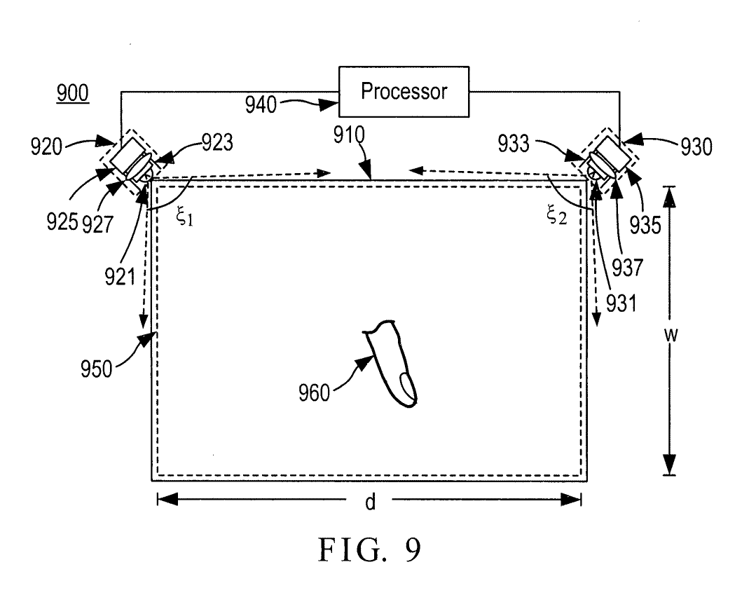

FIG. 9 is a schematic view of an optical touch screen system 900 according to an embodiment of the invention. The system 900 includes a display screen 910, a first lighting and sensing module 920, a second lighting and sensing module 930, and a processor 940.

The display screen 910 displays visual prompts to users in order to further control the human-machine interface. In this embodiment, the display screen 910 is preferably an LCD. The operation principle of the optical touch screen system 900 according to the invention can be implemented on various screens without any affection. Thus, the display screen 910 can be a CRT, LED, or plasma display screen.

The first lighting and sensing module 920 and the second lighting and sensing module 930 are mounted at two adjacent corners of the display screen 910 to thereby form a first visual field ξ₁ and a second visual field ξ₂ above the display screen 910, respectively. The first visual field ξ₁ and the second visual field ξ₂ intersect to form a touch area 950 above the display screen. The first lighting and sensing module 920 and the second lighting and sensing module 930 detect an object 960 entering the touch area 950, and generate a first electrical position signal and a second electrical position signal, respectively.

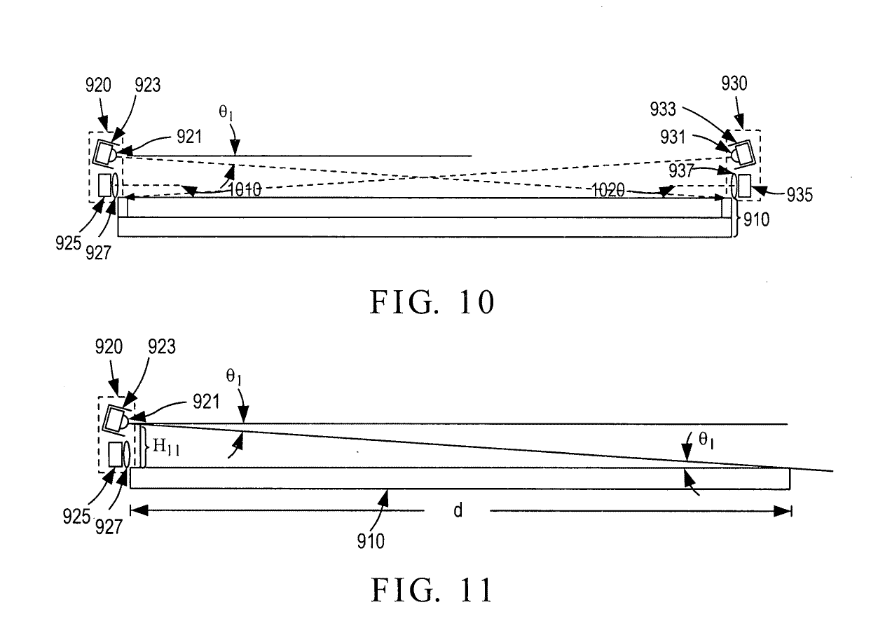

FIG. 10 is a side view of the optical touch screen system 900 according to an embodiment of the invention. As shown in FIG. 10, the first lighting and sensing module 920 includes a first lighting device 921, a first mask 923, and a first sensing device 925. The second lighting and sensing module 930 includes a second lighting device 931, a second mask 933, and a second sensing device 935. The first sensing device 925 has a first lens 927, and the second sensing device 935 has a second lens 937.

The first lighting device 921 and the second lighting device 931 are preferably an LED light source, and cover the lighting path with the first mask 923 and the second mask 933, respectively, to thereby generate a directive light. The directive light of the first and the second lighting devices 921 and 931 directly illuminate on a surface of the display screen 910 at an angle of depression (a first mount angle θ₁ and a second mount angle θ₂), respectively. The first and the second lighting devices 921 and 931 are each an LED. FIG. 11 is a schematic view of calculating the first mount angle θ₁ according to an embodiment of the invention. In addition, the first and the second lighting devices 921 and 931 can be an infrared or laser LED.

The first lens 927 and the second lens 937 are coupled to plural rows of sensing units of the first sensing device 925 and the second sensing device 935, respectively, in order to pass a light with a specific wavelength to thereby obtain a reflective light from the object 960. An axis 1010 of the first lens 927 is parallel to the display screen 910, and an axis 1020 of the second lens 937 is parallel to the display screen 910.

The first sensing device 925 and the second sensing device 935 are each preferably a CMOS sensing device. In addition, the first sensing device 925 and the second sensing device 935 can be a CCD sensing device. Each of the first sensing device 925 and the second sensing device 935 has plural rows of sensing units to thereby sense a reflective light from the object 960 and generate a first sensing height H₁₂ and a second sensing height H₂₂, respectively. Since the first sensing device 925 and the second sensing device 935 generate the first sensing height H₁₂ and the second sensing height H₂₂, respectively, the resolution thereof can be 160×16, 160×32, and 640×32.

As shown in FIG. 10, the optical touch screen system 900 uses two CMOS sensing devices 925, 935 and mounts the first lighting device 921 above the CMOS sensing device 925 and the second lighting device 931 above the CMOS sensing device 935. In other embodiments, the first lighting device 921 and the second lighting device 931 can be implemented at the left or right upper side of the CMOS sensing devices 925 and 935, respectively. In addition, each of the CMOS sensing devices 925 and 935 can be implemented with plural lighting devices.

The first mask 923 and the second mask 933 are employed to cover the lighting paths of the lighting devices. The surface of the display screen 910 is directly illuminated by the lighting devices at an angle of depression (a first mount angle θ₁ and a second mount angle θ₂). When using an object to take a touch and control action, the CMOS sensing devices 925, 935 receive a reflective light. Since the lighting devices illuminate at an angle (a first mount angle θ₁ and a second mount angle θ₂) on the basis of the display screen, the light is reflected by the touching object, and the CMOS sensing devices 925, 935 receive an image in a beam form. The height of the beam is getting higher as the touching object is getting closer to the CMOS sensing devices 925, 935.

As shown in FIGS. 11 and 9, the first lighting device 921 is mounted at a first mount location H₁₁ from the display screen 910 in order to illuminate the touch area 950. The first lighting device 921 has an axis of a lighting plane to form the first mount angle θ₁ with respect to the display screen 910, where 0°≦θ₁≦30°. The first mount angle θ₁ can be expressed as:

$${θ}_{1} = {sin}^{- 1} ( \frac{{H}_{11}}{\sqrt{{( d )}^{2} + {( {H}_{11} )}^{2}}} ) ,$$

where H₁₁ indicates a first mount location, and d indicates the length of the touch area 950. In this embodiment, the length of the touch area 950 is equal to the farthest lighting distance of the first lighting device 921. In other embodiments, the diagonal length of the touch area 950 is used as the farthest lighting distance of the first lighting device 921. In this case, (d)² in the above equation can be changed into (d)²+(w)², where w indicates the width of the touch area 950.

Similarly, the second lighting device 931 is mounted at a second mount height H₂₁ from the display screen 910 in order to illuminate the touch area 950. The second lighting device 931 has an axis of a lighting plane to form the second mount angle θ₂ with respect to the display screen 910, where 0°≦θ₂≦30°. The second mount angle θ₂ can be expressed as:

$${θ}_{2} = {sin}^{- 1} ( \frac{{H}_{21}}{\sqrt{{( d )}^{2} + {( {H}_{21} )}^{2}}} ) ,$$

where H₂₁ indicates a second mount height, and d indicates the length of the touch area 950. In other embodiments, (d)² in the above equation can be changed into (d)²+(w)², where w indicates the width of the touch area 950.

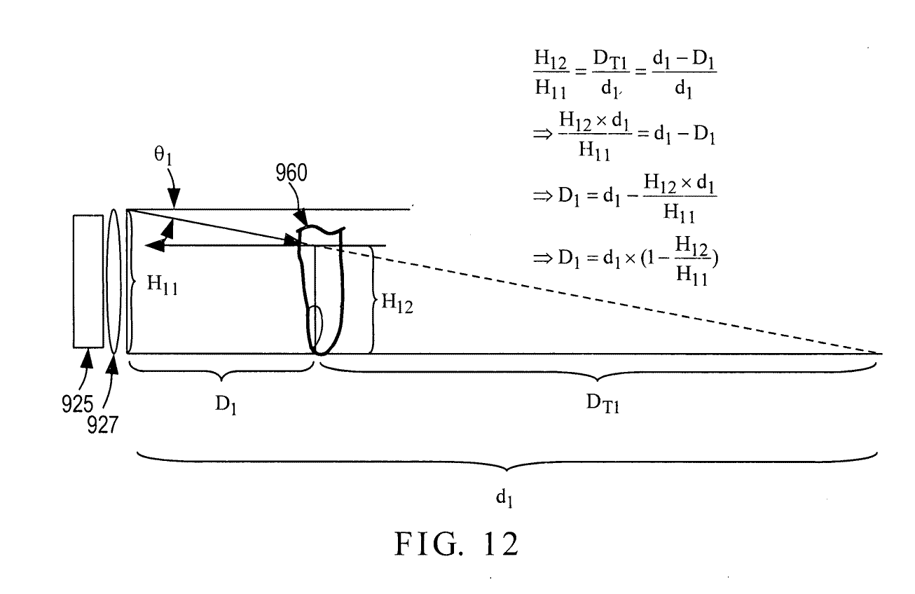

FIG. 12 is a schematic view of calculating the distance from a touching object 960 to the first lighting and sensing module 920 according to an embodiment of the invention. The sizes of the lighting devices 921, 931, the masks 923, 933, the sensing devices 925, 935, and the lens 927, 937 are all very small, and thus the first mount location H₁₁ and the second mount height H₂₁ are met with a largest area sensed by the first sensing device 925 and the second sensing device 935, respectively. Therefore, the distance D1 from the touching object 960 to the first lighting and sensing module 920 can be expressed as:

$$D 1 = {d}_{1} ( 1 - \frac{{H}_{12}}{{H}_{11}} ) ,$$

where H₁₂ indicates a first sensing height, H₁₁ indicates a first mount location of the first lighting device 921, and d₁ indicates the distance between the first lighting device 921 and an intersection of the display screen and a light from the first lighting device 921. In this embodiment, d₁ is equal to the length of the touch area 950. In other embodiments, d₁ can indicate the diagonal length of the touch area 950, H₁₁=d₁*tan(θ₁), and θ₁ indicates the first mount angle.

Similarly, the distance D2 from the touching object 960 to the second lighting and sensing module 930 can be expressed as:

$$D 2 = {d}_{2} ( 1 - \frac{{H}_{22}}{{H}_{21}} ) ,$$

where H₂₂ indicates a second sensing height, H₂₁ indicates a second mount height of the second lighting device 931, d₂ indicates the distance between the second lighting device 931 and an intersection of the display screen and a light from the second lighting device 931, H₂₁=d₂*tan(θ₂), and θ₂ indicates the second mount angle.

It is known from FIG. 12 that the magnitude of the first sensing height H₁₂ just equals to the first mount location H₁₁ of the first lighting device 921 when the touching object 960 locates right in front of the first lighting and sensing module 920. Thus, the distance D1 from the touching object 960 to the first lighting and sensing module 920 equals to zero. The first and the second lighting and sensing modules 920 and 930 can output the distances D1 and D2 as the first and the second electrical position signals, respectively.

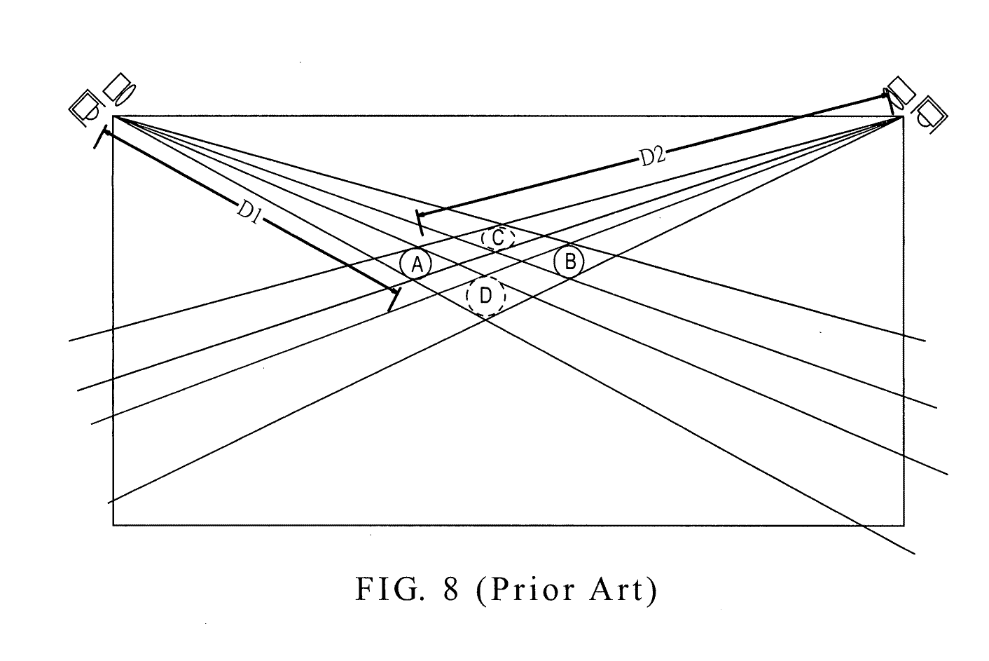

Since the processor 940 receives the distance D1 from the object 960 to the first lighting and sensing module 920 and the distance D2 from the object 960 to the second lighting and sensing module 930, it is able to accurately calculate the position of the object 960 based on the distances D1 and D2. Therefore, the ghost points (C, D) in FIG. 8 can be eliminated to further increase the recognition accuracy.

For simplifying the design of the first and the second lighting and sensing modules 920 and 930, there is no need to calculate the distances D1 and D2 for the first and the second lighting and sensing modules 920 and 930, respectively. The first and the second lighting and sensing modules 920 and 930 output the first and the second sensing heights H₁₂ and H₂₂ as the first and the second electrical position signals, respectively.

The processor 940 is connected to the first and the second lighting and sensing modules 920 and 930 in order to generate the distances D1 and D2 for the object 960 according to the first and the second electrical position signals H₁₂ and H₂₂, so as to further generate the position of the object 960.

In this embodiment, the first mount location H₁₁ and the second mount height H₂₁ are related to the mounting of the first lighting device 921 and the second lighting device 931. When the first and the second lighting devices 921 and 931 are mounted, the first mount location H₁₁ and the second mount height H₂₁ are determined. Accordingly, the first mount angle θ₁ and the second mount angle θ₂ are determined, and the distance d1 between the first lighting device 921 and an intersection of the display screen and a light from the first lighting device 921 and the distance d2 between the second lighting device 931 and an intersection of the display screen and a light from the second lighting device 931 are also determined. Therefore, it needs only the first sensing height H₁₂ and the second sensing height H₂₂ to calculate the distance D1 from the touching object 960 to the first lighting and sensing module 920 and the distance D2 from the touching object 960 to the second lighting and sensing module 930.

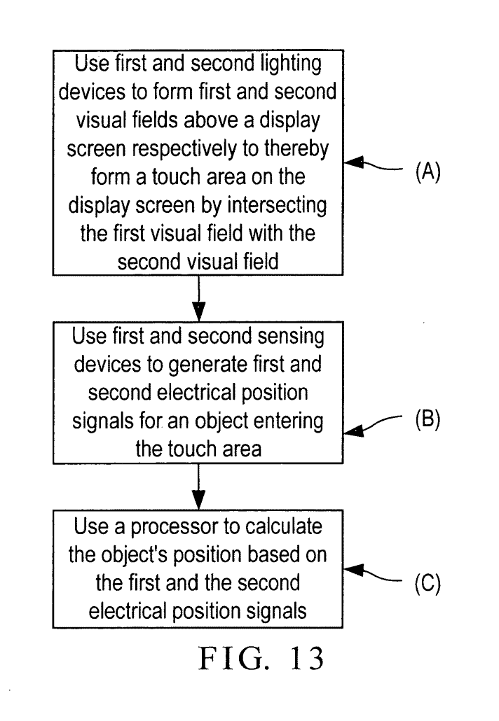

FIG. 13 a control flowchart of an optical touch screen method according to an embodiment of the invention, which is applied to a display screen 910 in order to obtain the position where a user touches the display screen. As cited above, two corners of the display screen 910 are mounted a first lighting and sensing module 920 and a second lighting and sensing module 930, respectively. The two corners locate at the same side of the display screen 910, and preferably at the upper of the display screen 910. The first lighting and sensing module 920 includes a first lighting device 921 and a first sensing device 925, and the second lighting and sensing module 930 includes a second lighting device 931 and a second sensing device 935. The first lighting device 921 is mounted at a first mount location H₁₁ from the display screen 910, and has an axis of a lighting plane to form a first mount angle θ₁ with respect to the display screen. The second lighting device 931 is mounted at a second mount height H₂₁ from the display screen 910, and has an axis of a lighting plane to form a second mount angle θ₂ with respect to the display screen.

First, in step (A), the first and the second lighting devices 921 and 931 are used to form a first and a second visual fields ξ₁ and ξ₂ above a display screen respectively, so as to form a touch area 950 on the display screen.

Next, in step (B), the first and the second sensing devices 925 and 935 are used to generate a first and a second electrical position signals for an object 960 entering the touch area 950.

Finally, in step (C), a processor 940 is used to calculate a position of the object 960 based on the first and the second electrical position signals.

The control flowchart of an optical touch screen method as shown in FIG. 13 can be applied to a second object entering the touch area 950, so as to obtain the accurate position of the second object. Thus, when two fingers touch and control (as shown in FIG. 8), the method can obtain the accurate coordinates of the two fingers and exclude the ghost points. Therefore, the method is suitable for multiple touching objects.

For the condition in FIG. 8, the distance D11 from the first object to the first lighting and sensing module 920 can be expressed as:

$$D 11 = {d}_{1} ( 1 - \frac{{H}_{12}}{{H}_{11}} ) ,$$

where H₁₂ indicates a first sensing height generated by the first lighting and sensing module 920 for the first object, H₁₁ indicates a first mount location of the first lighting device 921, d₁ indicates the length of the touch area 950, H₁₁=d₁*tan(θ₁), and θ₁ indicates a first mount angle formed by intersecting an axis of a lighting plane of the first lighting device 921 with the display screen. The distance D12 from the first object to the second lighting and sensing module 930 can be expressed as:

$$D 12 = {d}_{1} ( 1 - \frac{{H}_{22}}{{H}_{21}} ) ,$$

where H₂₂ indicates a second sensing height generated by the second lighting and sensing module 930 for the first object, H₂₁ indicates a second mount height of the second lighting device 931, d₁ indicates the length of the touch area 950, H₂₁=d₂*tan(θ₂), and θ₂ indicates a second mount angle formed by intersecting an axis of a lighting plane of the second lighting device 931 with the display screen.

The distance D21 from the second object to the first lighting and sensing module 920 can be expressed as:

$$D 21 = {d}_{1} ( 1 - \frac{{H}_{2 \_ 12}}{{H}_{11}} ) ,$$

where H₂_{_{—}}₁₂ indicates a third sensing height generated by the first lighting and sensing module 920 for the second object. The distance D22 from the second object to the second lighting and sensing module 930 can be expressed as:

$$D 22 = {d}_{1} ( 1 - \frac{{H}_{2 \_ 22}}{{H}_{21}} ) ,$$

where H₂_{_{—}}₂₂ indicates a fourth sensing height generated by the second lighting and sensing module 930 for the second object. For multiple objects, such as three fingers to touch, such distance equations can be derived from the inventive system and method by a person skilled in the art, and thus a detailed description is deemed unnecessary.

Existing optical touch techniques use two CMOS sensing devices to collect images for calculation of two touching objects. Each CMOS sensing device can obtain two vector results derived from the reflected light sources. After the combination, the two CMOS sensing devices can have four vector intersections, two of which being real and indicating the accurate coordinates of the objects, and the other two being the ghost points. If the ghost points are incorrectly determined, the hand gesture can be incorrectly determined. Therefore, the invention changes the incident angles of the light sources and masks the undesired light sources such that the reflective images can have the effect of image heights for a subsequent corresponding solid image conversion to thereby exclude the ghost points and obtain the accurate position of a touching object. Thus, the accuracy can be effectively provided, even for multiple touching objects. In addition, no additional hardware, such as the expensive CMOS sensing devices, is required, and the data processing can be implemented in firmware directly.

As compared with the prior art, the invention changes the incident angles of the light sources and masks the undesired light sources such that the reflective images can have the effect of image heights when the light illuminates the objects, and further uses the first and the second sensing devices 935 to extract the solid images with important information for using the position information of the objects to exclude the ghost points in the subsequent processes. Thus, the accuracy can be effectively provided, even for multiple touching objects. In addition, no additional hardware, such as the expensive CMOS sensing devices, is required, and the data processing can be implemented directly in the processor by firmware.

Although the present invention has been explained in relation to its preferred embodiment, it is to be understood that many other possible modifications and variations can be made without departing from the spirit and scope of the invention as hereinafter claimed.

What is claimed is:

1. An optical touch screen system, comprising:
a display screen for displaying visual prompts;
a first lighting and sensing module and a second lighting and sensing module mounted at two adjacent corners of the display screen, respectively, for forming a first visual field and a second visual field above the display screen, so as to form a touch area on the display screen, wherein the first lighting and sensing module and the second lighting and sensing module detect an object entering the touch area and generate a first electrical position signal and a second electrical position signal respectively; and
a processor connected to the first lighting and sensing module and the second lighting and sensing module for recognizing a position of the object based on the first electrical position signal and the second electrical position signal so as to achieve a human-machine control,
wherein the first lighting and sensing module has a first lighting device mounted on a first mount location apart from the display screen to illuminate on a surface of the display screen at an auxiliary angle of a first mount angle, and the second lighting and sensing module has a second lighting device mounted on a second location apart from the display screen to illuminate on the surface of the display screen at an auxiliary angle of a second mount angle.

2. The system as claimed in claim 1, wherein the first lighting and sensing module further includes: a first sensing device which is mounted below the first lighting device and has plural rows of sensing units to sense a reflective light of the object so as to generate the first electrical position signal, such that the processor generates a first sensing height based on the first electrical position signal.

3. The system as claimed in claim 2, wherein the first lighting device has an axis of a lighting plane intersected with the display screen to form the first mount angle θ₁, where 0°≦θ₁≦30° and the first mount angle θ₁ is expressed as:
$${θ}_{1} = {sin}^{- 1} ( \frac{{H}_{11}}{\sqrt{{( d )}^{2} + {( {H}_{11} )}^{2}}} ) ,$$
in which H₁₁ indicates the first mount location and d indicates a length of the touch area; and the second lighting device has an axis of a lighting plane intersected with the display screen to form the second mount angle θ₂, where 0°≦θ₂≦30° and the second mount angle θ₂ is expressed as:
$${θ}_{2} = {sin}^{- 1} ( \frac{{H}_{21}}{\sqrt{{( d )}^{2} + {( {H}_{21} )}^{2}}} ) ,$$
in which H₂₁ indicates a second mount height and d indicates a length of the touch area.

4. The system as claimed in claim 3, wherein the first sensing device includes a first lens coupled to the plural rows of sensing units of the first sensing device for passing a light with a specific wavelength so as to obtain the reflective light of the object.

5. The system as claimed in claim 3, wherein a distance D1 from the object to the first lighting and sensing module is expressed as:
$$D 1 = {d}_{1} ( 1 - \frac{{H}_{12}}{{H}_{11}} ) ,$$
where H₁₂ indicates the first sensing height, H₁₁ indicates the first mount location of the first lighting device, d₁ indicates a length of the touch area, H₁₁=d₁*tan(θ₁), and θ₁ indicates the first mount angle.

6. The system as claimed in claim 5, wherein the second lighting and sensing module further includes: a second sensing device which is mounted below the second lighting device and has plural rows of sensing units to sense a reflective light of the object so as to generate the second electrical position signal, such that the processor generates a second sensing height based on the second electrical position signal, and includes a second lens coupled to the plural rows of sensing units of the second sensing device for passing a light with a specific wavelength so as to obtain the reflective light of the object, the second lens having an axis in parallel to the display screen; and wherein a distance D2 from the object to the second lighting and sensing module is expressed as:
$$D 2 = {d}_{2} ( 1 - \frac{{H}_{22}}{{H}_{21}} ) ,$$
where H₂₂ indicates the second sensing height, H₂₁ indicates the second mount height of the first lighting device, d₂ indicates the length of the touch area, H₂₁=d₂*tan(θ₂), and θ₂ indicates the second mount angle.

7. The system as claimed in claim 6, wherein the processor calculates the position of the object based on the distances D1 and D2.

8. The system as claimed in claim 7, wherein the first lighting device includes a first mask for masking light source of the first lighting device so as to make the light intersected with the display screen by the first mount angle, and the second lighting device includes a second mask for masking light source of the second lighting device so as to make the light the light intersected with the display screen by the second mount angle.

9. The system as claimed in claim 8, wherein the first and the second lighting devices are each a light emitting diode (LED).

10. The system as claimed in claim 9, wherein the first and the second lighting devices are each an infrared or a laser LED.

11. The system as claimed in claim 10, wherein the first and the second sensing devices are each a CCD or CMOS sensing device.

12. A method for recognizing a relative distance of an object in an optical touch screen system, the optical touch screen system including a display screen to recognize a position where a user touches the display screen, and a first and a second lighting and sensing modules mounted on two adjacent corners of the display screen, the first lighting and sensing module having a first lighting device and a first sensing device, the second lighting and sensing module having a second lighting device and a second sensing device, the first lighting device being mounted at a first mount location apart from the display screen and having an axis of a lighting plane to form a first mount angle θ₁ with respect to the display screen, the second lighting device being mounted at a second mount height from the display screen and having an axis of a lighting plane to form a second mount angle θ₂ with respect to the display screen, the method comprising the steps of:
(A) using the first and the second lighting devices to form a first and a second visual fields above a display screen respectively, so as to form a touch area on the display screen by intersecting the first visual field with the second visual field;
(B) using the first and the second sensing devices to generate a first and a second electrical position signals for an object entering the touch area; and
(C) using a processor to calculate a position of the object based on the first and the second electrical position signals.

13. The method as claimed in claim 12, wherein a distance D1 from the object to the first lighting and sensing module is expressed as:
$$D 1 = {d}_{1} ( 1 - \frac{{H}_{12}}{{H}_{11}} ) ,$$
where H₁₂ indicates the first sensing height, H₁₁ indicates the first mount location of the first lighting device, d₁ indicates a distance between the first lighting device and an intersection of the display screen and a light from the first lighting device, and H₁₁=d₁*tan(θ₁).

14. The method as claimed in claim 13, wherein a distance D2 from the object to the second lighting and sensing module is expressed as:
$$D 2 = {d}_{2} ( 1 - \frac{{H}_{22}}{{H}_{21}} ) ,$$
where H₂₂ indicates the second sensing height, H₂₁ indicates the second mount height of the first lighting device, d₂ indicates a distance between the second lighting device and an intersection of the display screen and a light from the second lighting device, and H₂₁=d₂*tan(θ₂).

15. The method as claimed in claim 14, wherein the processor calculates the position of the object based on the distances D1 and D2.

16. An optical touch screen system, comprising:
a display screen for displaying visual prompts;
a first lighting and sensing module and a second lighting and sensing module mounted at two adjacent corners of the display screen, respectively, for forming a first visual field and a second visual field above the display screen, so as to form a touch area on the display screen, wherein the first lighting and sensing module generates a first electrical position signal and a second electrical position signal when a first object enters in the touch area, and the second lighting and sensing module generates a third electrical position signal and a fourth electrical position signal when a second object enters in the touch area; and
a processor connected to the first lighting and sensing module and the second lighting and sensing module for recognizing positions of the first and the second objects based on the first, the second, the third, and the fourth electrical position signals, so as to eliminate ghost points caused by the first and the second objects in the first and the second lighting and sensing modules respectively;
wherein the first lighting and sensing module has a first lighting device mounted at a first mount location from the display screen to illuminate on a surface of the display screen at an auxiliary angle of a first mount angle, and the second lighting and sensing module has a second lighting device mounted at a second mount height from the display screen to illuminate on the surface of the display screen at an auxiliary angle of a second mount angle;
wherein a distance D11 from the first object to the first lighting and sensing module is expressed as:
$$D 11 = {d}_{1} ( 1 - \frac{{H}_{12}}{{H}_{11}} ) ,$$
where H₁₂ indicates a first sensing height generated by the first lighting and sensing module for the first object, H₁₁ indicates the first mount location of the first lighting device, H₁₁=d₁*tan(θ₁), and θ₁ indicates the first mount angle; the distance D12 from the first object to the second lighting and sensing module is expressed as:
$$D 12 = {d}_{1} ( 1 - \frac{{H}_{22}}{{H}_{21}} ) ,$$
where H₂₂ indicates a second sensing height generated by the second lighting and sensing module for the first object, H₂₁ indicates the second mount height of the second lighting device, H₂₁=d₂*tan(θ₂), and θ₂ indicates the second mount angle; the distance D21 from the second object to the first lighting and sensing module is expressed as:
$$D 21 = {d}_{1} ( 1 - \frac{{H}_{2 \_ 12}}{{H}_{11}} ) ,$$
where H₂_{_{—}}₁₂ indicates a third sensing height generated by the first lighting and sensing module for the second object; and the distance D22 from the second object to the second lighting and sensing module is expressed as:
$$D 22 = {d}_{1} ( 1 - \frac{{H}_{2 \_ 22}}{{H}_{21}} ) ,$$
where H₂_{_{—}}₂₂ indicates a fourth sensing height generated by the second lighting and sensing module for the second object.
